(19) United States
(12) Patent Application Publication
(10) Pub. No.: US 2022/0066576 A1
(43) Pub. Date: Mar. 3, 2022

(54) ACTIVE STYLUS, CHARGING METHOD THEREOF AND MOBILE COMPUTING DEVICE USING THE SAME

(71) Applicant: Acer Incorporated, New Taipei City (TW)

(72) Inventor: Chueh-Pin KO, New Taipei City (TW)

(73) Assignee: Acer Incorporated, New Taipei City (TW)

(21) Appl. No.: 17/211,477

(22) Filed: Mar. 24, 2021

(30) Foreign Application Priority Data
Aug. 26, 2020 (TW) 109129197

(51) Int. Cl. G06F 3/0354; G06F 3/038; G09G 5/10; G06F 3/041; H02J 7/35

(52) U.S. Cl. CPC G06F 3/03545; G06F 3/038; G06F 2203/0384; G06F 3/041; H02J 7/35; G09G 5/10

(57) ABSTRACT

An active stylus and a charging method thereof and a mobile computing device using the same are provided. The charging method of an active stylus includes the following steps. A wireless signal is emitted to a touch device of a mobile computing device by an active stylus to obtain an attitude or a position of the active stylus relative to the mobile computing device, wherein the active stylus includes a solar panel. A light-emitting area of the mobile computing device is determined according to the attitude or the position of the active stylus relative to the mobile computing device. A light is emitted in the light-emitting area by a light-emitting unit of the mobile computing device, such that the solar panel of the active stylus receives the light for charging a battery of the active stylus.

This application claims the benefit of Taiwan application Serial No. 109129197, filed Aug. 26, 2020, the subject matter of which is incorporated herein by reference.

### BACKGROUND OF THE INVENTION

### Field of the Invention

The invention relates in general to a stylus and a charging method thereof and a computing device using the same, and more particularly to an active stylus and a charging method thereof and a mobile computing device using the same.

### Description of the Related Art

The mobile computing device can collocate with a stylus to provide the user with convenience in writing and drawing. In recent years, an active stylus is provided. The active stylus requires an independent battery whose size directly affects the duration of the active stylus.

Normally, the battery of the active stylus is replaceable. However, a heavy user of the stylus will be bothered with the frequent replacement of the battery. For the active stylus to be more practical, the research personnel are devoted to providing various wireless charging technologies with which the active stylus can be wirelessly charged.

### SUMMARY OF THE INVENTION

The invention is directed to an active stylus and a charging method thereof and a mobile computing device using the same. A light-emitting area is determined according to the attitude or the position of the active stylus relative to the mobile computing device, such that the light-emitting area can correspond to the current attitude or position of the active stylus, and the solar panel of the active stylus can receive a light and charge the active stylus.

According to one embodiment of the present invention, a charging method of an active stylus is provided. The charging method of an active stylus includes the following steps. A wireless signal is emitted to a touch device of a mobile computing device by an active stylus to obtain an attitude or a position of the active stylus relative to the mobile computing device. The active stylus includes a solar panel. A light-emitting area of the mobile computing device is determined according to the attitude or the position of the active stylus relative to the mobile computing device. A light is emitted in the light-emitting area by a light-emitting unit of the mobile computing device, such that the solar panel of the active stylus receives the light for charging a battery of the active stylus.

According to another embodiment of the present invention, a mobile computing device is provided. The mobile computing device includes a touch device, a regional analysis unit, a light-emitting unit and a control unit. The touch device is configured to receive a wireless signal emitted by an active stylus to obtain an attitude or a position of the active stylus relative to the mobile computing device. The active stylus includes a solar panel. The regional analysis unit is configured to obtain a light-emitting area according to the attitude or the position of the active stylus relative to the mobile computing device. The control unit is configured to control the light-emitting unit to emit a light in the light-emitting area, such that the solar panel of the active stylus receives the light for charging the active stylus.

According to an alternate embodiment of the present invention, an active stylus is provided. The active stylus includes a battery, a solar panel, a processing unit and a emission unit. The solar panel is connected to the battery. The processing unit is configured to analyze an attitude or a position of the active stylus relative to a mobile computing device. The emission unit is configured to emit a wireless signal to a touch device of the mobile computing device, such that the mobile computing device obtains the attitude or the position and makes a light-emitting unit of the mobile computing device area emit a light in a light-emitting area. The solar panel of the active stylus receives the light for charging the active stylus.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A to 1B are schematic diagrams of a mobile computing device and an active stylus according to an embodiment;

FIG. 2 is a block diagram of a mobile computing device and an active stylus according to an embodiment;

FIG. 3 is a flowchart of a charging method of an active stylus according to an embodiment;

FIGS. 4A to 4B are schematic diagrams of detecting attitude according to an embodiment; and

FIGS. 5A to 5F are design diagrams of laptop and active stylus.

### DETAILED DESCRIPTION OF THE INVENTION

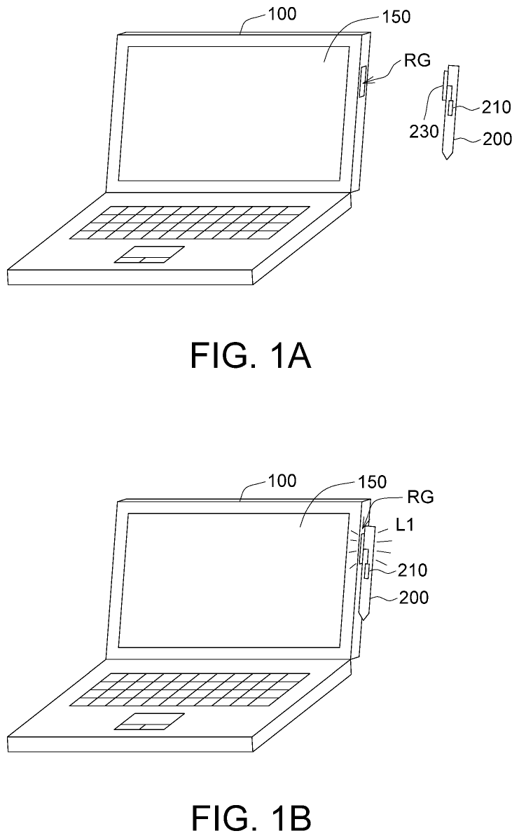

Referring to FIGS. 1A to 1B, schematic diagrams of a mobile computing device 100 and an active stylus 200 according to an embodiment are shown. The present embodiment provides a wireless charging technology, which allows the active stylus 200 to be charged through the mobile computing device 100 without using a charging cable. The mobile budge device 100 can be realized by a smart phone, a PC tablet, a smart watch, or a laptop. The active stylus 200 can be realized by a capacitive stylus, an electromagnetic stylus, a resistive stylus, or an ultrasonic stylus. The active stylus 200 includes a battery 210 and a solar panel 230. The mobile computing device 100 has a light-emitting area RG. As indicated in FIG. 1B, when the active stylus 200 is disposed in the light-emitting area RG of the mobile computing device 100, the light-emitting area RG emits a light L1, such that the solar panel 230 of the active stylus 200 receives the light L1 for charging the active stylus 200.

In the present embodiment, the light-emitting area RG does not have to be fixed at a specific position. The mobile computing device 100 can determine the light-emitting area RG according to an attitude or a position of the active stylus 200 relative to the mobile computing device 100, such that the light-emitting area RG can correspond to the current attitude or position of the active stylus 200 and make the solar panel 230 of the active stylus 200 receive the light L1 and charge the active stylus 200.

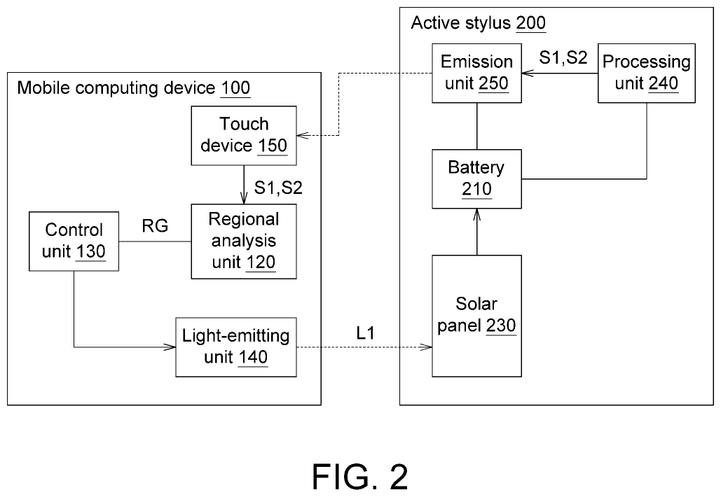

Referring to FIG. 2, a block diagram of a mobile computing device 100 and an active stylus 200 according to an embodiment is shown. The mobile computing device 100 includes a touch device 150, a regional analysis unit 120, a control unit 130 and a light-emitting unit 140. The regional analysis unit 120 and the control unit 130 can be realized by a circuit, a chip, a circuit board, an array code or a storage device for storing programming codes. The touch device 150 can be realized by a touch panel without any display function or a touch display includes a touch panel and a display panel. The light-emitting unit 140 can be realized by a backlight module, a light-emitting diode, or an organic light-emitting diode of the touch device 150 including the display panel. The active stylus 200 includes a solar panel 230, a battery 210, a processing unit 240 and an emission unit 250. The battery 210 can be realized by a lithium battery. The processing unit 240 can be realized by a circuit, a chip, a circuit board, an array code or a storage device for storing programming codes. The emission unit 250 can be realized by a Bluetooth module, an NFC module or a wireless RF module.

The solar panel 230 is connected to the battery 210. The processing unit 240 is configured to analyze an attitude S1 or a position S2 of the active stylus 200 relative to the mobile computing device 100. The emission unit 250 is configured to transmit the attitude S1 or the position S2 to the mobile computing device 100.

The touch device 150 of the mobile computing device 100 is configured to receive the wireless signal emitted by the active stylus 200. The mobile computing device 100 performs calculation to obtain the attitude S1 or the position S2 of the active stylus 200 according to the wireless signal. The wireless signal can be realized by a Bluetooth signal, a Wi-Fi signal, or a UWB signal. Or, the active stylus 200 can directly operate on the touch device 150 to calculate the attitude S1 or the position S2 of the active stylus 200 through the electrodes disposed on the touch device 150. The regional analysis unit 120 is configured to obtain a light-emitting area RG of the mobile computing device 100 according to the attitude S1 or the position S2 of the active stylus 200.

The control unit 130 is configured to control the light-emitting unit 150 to emit the light L1 in the light-emitting area RG, such that the solar panel 230 of the active stylus 200 receives the light L1 for charging the battery 210 of the active stylus 200.

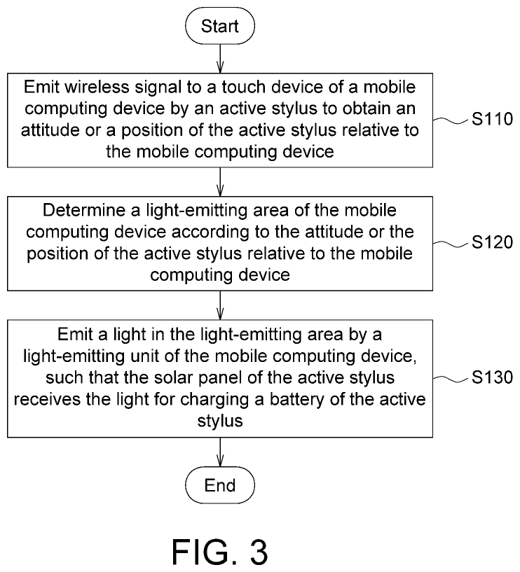

Operations of the mobile computing device 100 and the active stylus 200 are disclosed below with an accompanying flowchart. Referring to FIG. 3, a flowchart of a charging method of an active stylus according to an embodiment is shown. In step S110, a wireless signal is emitted to the touch device 150 of the mobile computing device 100 by the active stylus 200 to obtain an attitude S1 or a position S2 of the active stylus 200 relative to the mobile computing device 100. In the present step, after the attitude S1 or the position S2 is analyzed by the processing unit 240 of the active stylus 200, the attitude S1 or the position S2 is transmitted to the touch device 150 of the mobile computing device 100 by the emission unit 250. Or, after a wireless signal is emitted to the mobile computing device 100 by the emission unit 250, the mobile computing device 100 performs calculation to obtain the attitude S1 or the position S2 according to the wireless signal.

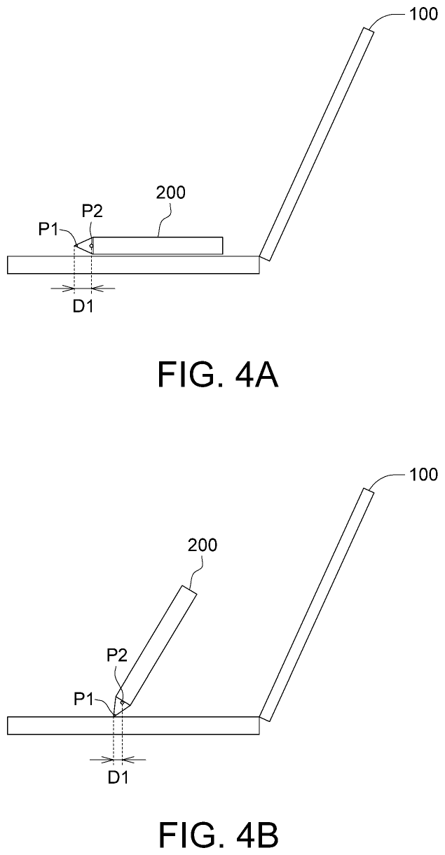

Referring to FIGS. 4A to 4B, schematic diagrams of detecting attitude S1 according to an embodiment according to an embodiment are shown. For example, the attitude S1 of the active stylus 200 can be obtained through the signal analysis of two signal emission points P1 and P2. As indicated in FIG. 4A, when the active stylus 200 is laid flat, the distance D1 between the two signal emission points P1 and P2 is the maximum. As indicated in FIG. 4B, when the active stylus 200 tilts to an angle, the distance D1 between the two signal emission points P1 and P2 is decreased. Thus, the angle of inclination can be obtained according to the distance D1 between the two signal emission points P1 and P2 or a look-up table.

The attitude S1 or the position S2 of the active stylus can be obtained by analyzing the active content and the passive content of the active stylus 200. Examples of the active content include the identification code, the state information (such as the weight, the length, the width, the height, the shape, the inclination, the rotation, the suspension, and the pressure of the stylus), and the electrical signal of the stylus (such as the number, the strength and the frequency of the signal). The passive content includes the information of the stylus detected by the sensor.

Next, in step S120, a light-emitting area RG of the mobile computing device 100 is obtained according to the attitude S1 or the position S2 of the active stylus 200 relative to the mobile computing device 100.

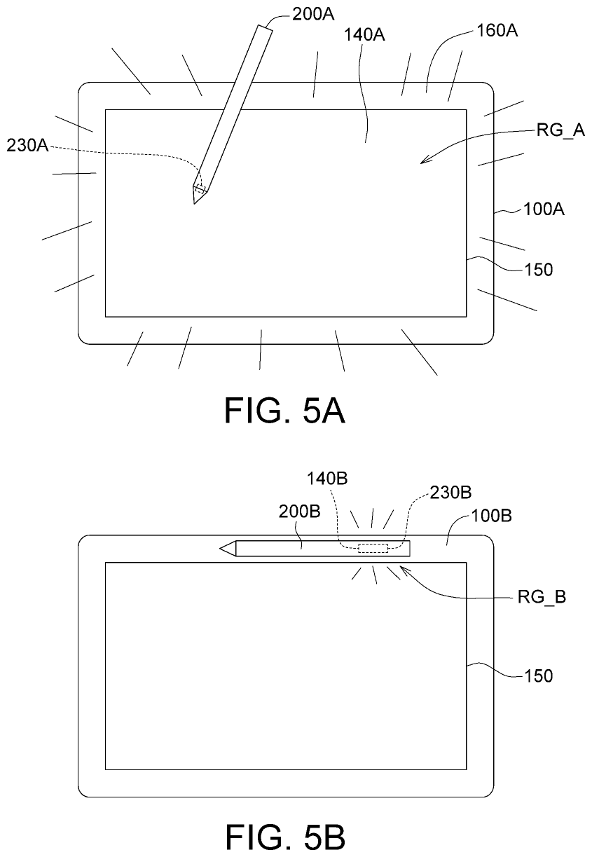

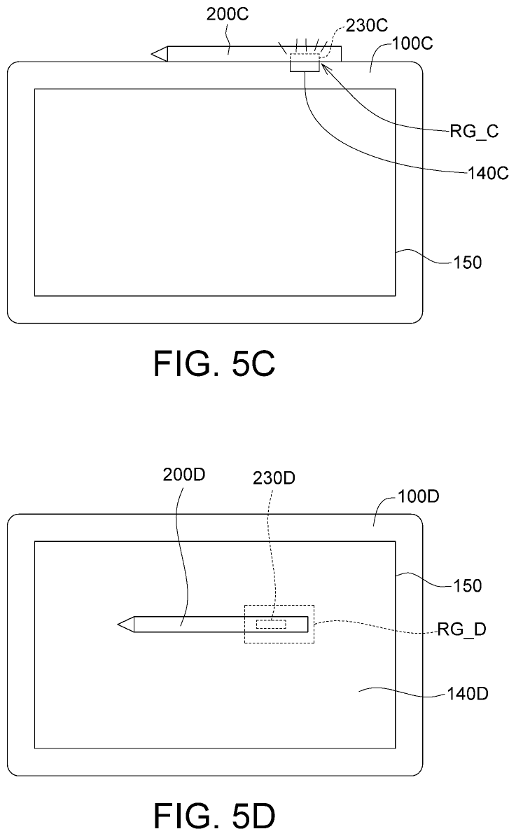

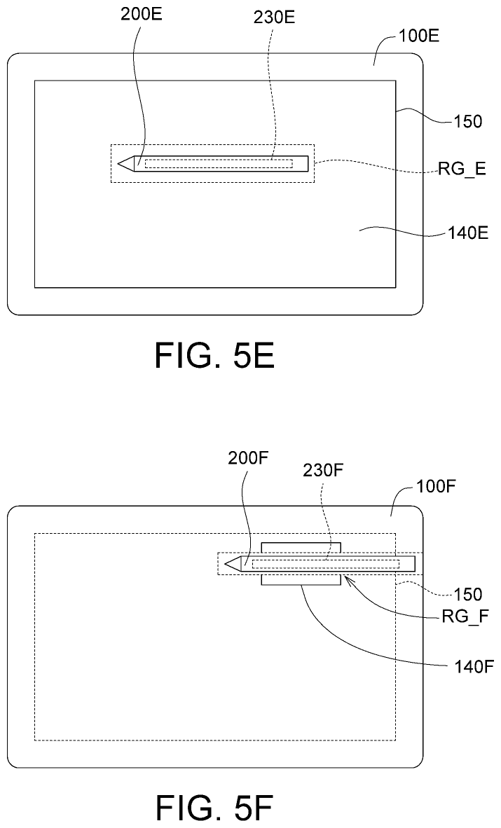

Referring to FIGS. 5A to 5F, design diagrams of mobile computing devices 100A to 100F and active styluses 200A to 200F are shown. As indicated in FIG. 5A, the solar panel 230A of the active stylus 200A is located at the tip, and the light-emitting unit 140 is a backlight module of the touch display 150 including the display panel. When the active stylus 200A writes on the touch screen of the mobile computing device 100A, the mobile computing device 100A determines that the light-emitting area RG_A is the entire display area. The solar panel 230A of the active stylus 200A receives a light of the touch screen and uses the light for charging. That is, the design of the present invention can support the write and charge function, and when the electrical capacity of the active stylus 200A is low, the user can continue to write with the active stylus 200A which is being charged without having to place the active stylus 200A at a specific position.

As indicated in FIG. 5B, the solar panel 230B of the active stylus 200B is located at the tail, and the light-emitting unit 140B is a light-emitting diode. When the active stylus 200B is absorbed on a surface of the frame of the mobile computing device 100B, the mobile computing device 100B determines that the light-emitting area RG_B is located on the surface of the frame. The solar panel 230B of the active stylus 200B receives a light and uses the received light for charging.

As indicated in FIG. 5C, the solar panel 230C of the active stylus 200C is located at the tail, and the light-emitting unit 140C is a light-emitting diode. When the active stylus 200C is absorbed on an upper side of a frame of the mobile computing device 100C, the mobile computing device 100C determines that the light-emitting area RG_C is located on the upper side of the frame. The solar panel 230C of the active stylus 200C receives a light and uses the received light for charging.

As indicated in FIG. 5D, the solar panel 230D of the active stylus 200D is located at the tail, and the light-emitting unit 140D is a backlight module of the touch device 150 including the display panel. When the active stylus 200D is laid flat on the touch device 150 of the mobile computing device 100D, the mobile computing device 100D determines that the light-emitting area RG_D is a partial area of the touch device 150. The light-emitting unit 140D emits a light only in the light-emitting area RG_D (using a backlight module such as mini-LED, micro-LED to precisely control the light-emitting region). The solar panel 230D of the active stylus 200D receives a light and uses the received light for charging.

As indicated in FIG. 5E, the solar panel 230E of the active stylus 200E is located on the body, and the light-emitting unit 140E is a backlight module of the touch device 150. When the active stylus 200E is laid flat on the touch device 150 of the mobile computing device 100E, the mobile computing device 100E determines that the light-emitting area RG_E is a partial area of the touch device 150. The light-emitting unit 140E enhances the brightness in the light-emitting area RG_E (the entire touch device 150 still shows the original content). The solar panel 230E of the active stylus 200E receives a light and uses the received light for charging.

As indicated in FIG. 5F, the solar panel 230F of the active stylus 200F is located on the body, and the light-emitting unit 140F is located on a light-emitting diode in a slot. When the active stylus 200F is embedded into an accommodation grove of the mobile computing device 100F, the mobile computing device 100F determines that the light-emitting area RG_F is an inner-wall of the accommodation grove. The solar panel 230F of the active stylus 200F receives a light and uses the received light for charging.

The said light-emitting unit 140 can be realized by an LED indicator, an LCD backlight module or an OLED, each can be used as a source of a high-luminance light. The current outputted by the solar panel 230 is relevant to the luminance. According to the present design, the light-emitting unit 140 provides a high-luminance light at a short distance to increase the charging efficiency.

Then, in step S130, a light L1 is emitted in the light-emitting area RG by the light-emitting unit 140, such that the solar panel 230 of the active stylus 200 receives the light L1 for charging the active stylus 200.

According to the above embodiments, when the active stylus 200 gets closer to the mobile computing device 100, the mobile computing device 100 can irradiate a light on the solar panel 230 at a short distance to perform a non-contact light charging on the battery 210 without using a charging cable.

Besides, since the active stylus 200 and the mobile computing device 100 do not require any charging contact points, the external appearance can be simplified and the aesthetics of the external appearance can be maintained.

Moreover, since the active stylus 200 is charged using the light, the existing backlight module or light-emitting diode of the mobile computing device 100 can be used and there is no need to install any additional light source. In comparison to the design using wireless charging, the present design can save more elements.

Furthermore, the determination of the light-emitting area RG can provide the high-luminance light at a shortest distance, such that the charging efficiency can be optimized.

Additionally, various storage methods of the active stylus 200 (such as external absorption, external clamping, hidden type) are all based on the non-contact light charging method of the present design.

The present design can support the write and charge function, and when the electrical capacity of the active stylus is low, the user can continue to write with the active stylus which is being charged without having to place the active stylus at a specific position.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A charging method of an active stylus, comprising:
emitting a wireless signal to a touch device of a mobile computing device by the active stylus to obtain an attitude or a position of the active stylus relative to the mobile computing device, wherein the active stylus comprises a solar panel;
determining a light-emitting area of the mobile computing device according to the attitude or the position of the active stylus relative to the mobile computing device, wherein the light-emitting area is located in a frame, or an inner-wall of an accommodation grove of the mobile computing device; and
emitting a light in the light-emitting area by a light-emitting unit of the mobile computing device, such that the solar panel of the active stylus receives the light for charging a battery of the active stylus.

2. The charging method of the active stylus according to claim 1, wherein the solar panel is located on a body, a tip, or a tail of the active stylus.

3. (canceled)

4. The charging method of the active stylus according to claim 1, wherein the light-emitting unit enhances a brightness in the light-emitting area.

5. The charging method of the active stylus according to claim 1, wherein the touch device includes a display panel, and the light-emitting unit is a backlight module, a light-emitting diode or an organic light-emitting diode of the touch device.

6. The charging method of the active stylus according to claim 1, wherein the light-emitting unit emits the light only in the light-emitting area.

7. The charging method of the active stylus according to claim 1, wherein the wireless signal is a Bluetooth signal, a Wi-Fi signal, or a UWB signal.

8. The charging method of the active stylus according to claim 1, wherein the active stylus is a capacitive stylus, an electromagnetic stylus, a resistive stylus, or an ultrasonic stylus.

9. A mobile computing device, comprising:
a touch device configured to receive a wireless signal emitted by an active stylus to obtain an attitude or a position of the active stylus relative to the mobile computing device, wherein the active stylus comprises a solar panel;
a regional analysis unit configured to obtain a light-emitting area according to the attitude or the position of the active stylus relative to the mobile computing device;
a light-emitting unit; and
a control unit configured to control the light-emitting unit to emit a light in the light-emitting area, such that the solar panel of the active stylus receives the light for charging the active stylus, wherein the light-emitting area is located in a frame, or an inner-wall of an accommodation grove of the mobile computing device.

10. (canceled)

11. The mobile computing device according to claim 9, wherein the touch device includes a display panel, and the light-emitting unit is a backlight module, a light-emitting diode or an organic light-emitting diode of the touch device.

12. The mobile computing device according to claim 9, wherein the light-emitting unit emits the light only in the light-emitting area.

13. The mobile computing device according to claim 9, wherein the light-emitting unit enhances a brightness in the light-emitting area.

14. The mobile computing device according to claim 9, wherein the wireless signal is a Bluetooth signal, a Wi-Fi signal, or a UWB signal.

15. The mobile computing device according to claim 9, wherein the active stylus is a capacitive stylus, an electromagnetic stylus, a resistive stylus, or an ultrasonic stylus.

16. An active stylus, comprising:
a battery;
a solar panel connected to the battery;
a processing unit configured to analyze an attitude or a position of the active stylus relative to a mobile computing device; and
an emission unit configured to emit a wireless signal to a touch device of the mobile computing device, such that the mobile computing device obtains the attitude or the position of the active stylus and a light-emitting unit of the mobile computing device emits a light in a light-emitting area, wherein the solar panel of the active stylus receives the light for charging the active stylus, and the solar panel is located on a tip, or a tail of the active stylus.

17. (canceled)

18. The active stylus according to claim 16, wherein the wireless signal is a Bluetooth signal, a Wi-Fi signal, or a UWB signal.

19. The active stylus according to claim 16, wherein the active stylus is a capacitive stylus, an electromagnetic stylus, a resistive stylus, or an ultrasonic stylus.

20. The active stylus according to claim 16, wherein the light-emitting area is located in a display area, a frame, or an inner-wall of an accommodation grove of the mobile computing device.
